(19) United States
(12) Patent Application Publication
(10) Pub. No.: US 2005/0263257 A1
(43) Pub. Date: Dec. 1, 2005

(54) Extraction profile with adjustable centering mechanism

(75) Inventors: Melf Hansen, Gondelsheim (DE); Matthias Maier, Esslingen (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: BOS GmbH & Co. KG, Ostifildern (DE)

(21) Appl. No.: 11/117,042

(22) Filed: Apr. 27, 2005

(30) Foreign Application Priority Data
May 27, 2004 (DE) 10 04 020531.0-24

(51) Int. Cl. B60J 1/20

(52) U.S. Cl. 160/370.22

(57) ABSTRACT

A window shade for motor vehicles is provided that includes a rotatably supported winding shaft with one edge of a shade element fixed thereon. The other edge of the shade element is captured on an extraction rod, the ends of which are guided in guide rails. The distance between the guide rails changes significantly in the moving direction of the shade element, and therefore the length of the extraction rod can be telescopically varied. The extraction rod includes a center piece and two end pieces, with a differential gear ensuring that the center piece always remains centered relative to the end pieces. The position of the differential gear is adjustable in the longitudinal direction of the transverse edge of the shade element.

### FIELD OF THE INVENTION

This invention relates to window shades for motor vehicles and, in particular, to a window shade for modern car bodies that have relatively large windows.

### BACKGROUND OF THE INVENTION

Modern motor vehicle bodies can have relatively large windows. Because they admit a significant amount of sun radiation, these large windows can lead to a substantial heating of the vehicle interior. Even with vehicles having air conditioning systems, this heating can only be counteracted through significant energy consumption. Accordingly, motor vehicles are increasingly equipped with window shades.

One example of a window shade for a motor vehicle is disclosed in DE 100 57 760 A1. This window shade includes two guide rails that are arranged laterally adjacent to the rear window, with the ends of the window shade extraction or pull rod being guided within the guide rails. The length of the extraction rod is adjustable. The extraction rod is composed of a center piece and two end pieces that are displaceably arranged in the center piece in order to follow the lateral window contour. Actuation of window shade is achieved with the aid of thrust elements that are displaceably guided within the guide rails.

The center piece of the extraction rod has a tubular shape with oval cross section. The end pieces can be telescopically displaced in this center piece. In order to center the end pieces relative to the center piece, a rotatably supported gear wheel is provided that meshes with racks that are arranged on opposite sides and connected to the end pieces. As a result, movement of one end piece relative to the center piece results in an oppositely directed movement of the other end piece relative to the center piece. This arrangement is very effective at preventing transverse creases in the window shade caused by the center piece being in an out of center position. However, this window shade is very difficult to install.

### BRIEF SUMMARY OF THE INVENTION

Accordingly, in view of the foregoing, a general object of the present invention is to provide an improved window shade having an adjustable centering mechanism.

To this end, the window shade of the present invention includes a centering mechanism for ensuring that the center piece of the extraction rod remains largely centered. The centering mechanism consists of a gear that operates as a differential gear. The movement of one end piece relative to the center piece is transmitted to the other end piece in the opposite direction by the differential gear, with the second end piece being displaced by the same distance as the first end piece. When either end piece is actuated, both end pieces are displaced back and forth relative to the center piece by the same distance, however, in opposite directions. A forced centering of the center piece results when the end pieces are displaced relative to one another.

The position of the differential gear can be adjusted relative to the longitudinal direction of the edge of the shade element, which has a strip shape. This adjustment can be achieved either by displacing the transmission and coupling element in the center piece or by displacing and subsequently fixing the center piece relative to the shade element.

The differential gear can operate in accordance with the positive engagement principle or the frictional engagement principle. Although installation of a frictional engagement gear is not quite as complicated as a positive engagement gear, under certain circumstances the frictional engagement gear may not operate as precisely as would a positive engagement gear.

In any case, the center piece can advantageously consist of a tube, particularly a tube having a specialized cross-sectional shape. A tube having such a shape allows the end pieces to be displaced, but simultaneously prevents the end pieces from turning within the tube. The tube also separates the shade element from the centering mechanism and simultaneously protects the centering mechanism.

The guide system of the window shade preferably consists of guide rails that contain a guide groove. The invention can also be utilized in window shades in which the extraction rod has eyelets on its ends and is displaced along rod shaped guide rails.

Preferably, a spring drive and an electric motor are provided for displacing the shade. The spring drive is preferably arranged in the winding shaft while the electric motor drives the extraction rod. Such an arrangement makes allows the shade to be positively tensioned between the winding shaft and the extraction rod. According to another driving arrangement, the extraction rod is prestressed in the direction of the extracted position with the aid of springs while the winding shaft is driven by the electric motor.

The shade element itself preferably consists of a knitted fabric or a perforated, colored plastic sheet.

### BRIEF DESCRIPTION OF THE DRAWINGS

FIG. 1 is a rear view of an exemplary passenger motor vehicle having a rear window shade according to the present invention in the extracted position.

FIG. 2 is a front view of the rear window shade of FIG. 1.

FIG. 3 is a partially cutaway perspective view of the extraction rod of the rear window shade of FIG. 1.

FIG. 4 is a perspective view of the extraction rod for the rear window shade of FIG. 1.

FIG. 5 is a top view of an alternative embodiment of the extraction rod in the region of the pinion gear.

### DETAILED DESCRIPTION OF THE INVENTION

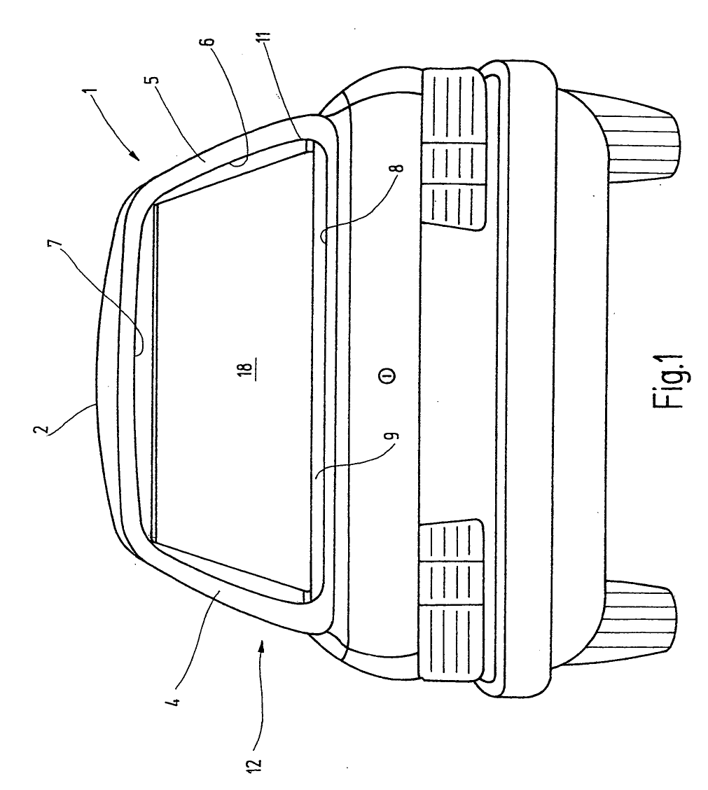

A schematic rear view of an illustrative passenger motor vehicle 1 having a roof 2, a trunk 3 and two C columns 4 and 5 is provided in FIG. 1. A rear window opening 6 is situated between the two C columns 4 and 5. The rear window opening is limited by a rear roof edge 7 on the top and a window sill 8 on the bottom. A rear window is held in the rear window opening 6 in a conventional manner, for example, by means of a rubber window seal. Inside the passenger motor vehicle 1, a rear window shelf 9 is situated in front of the inner side of the rear window. The rear window shelf 9 extends horizontally between the lower window edge 8 and a rear seat backrest that is not visible in FIG. 1. The rear window shelf 9 includes a straight slot 11.

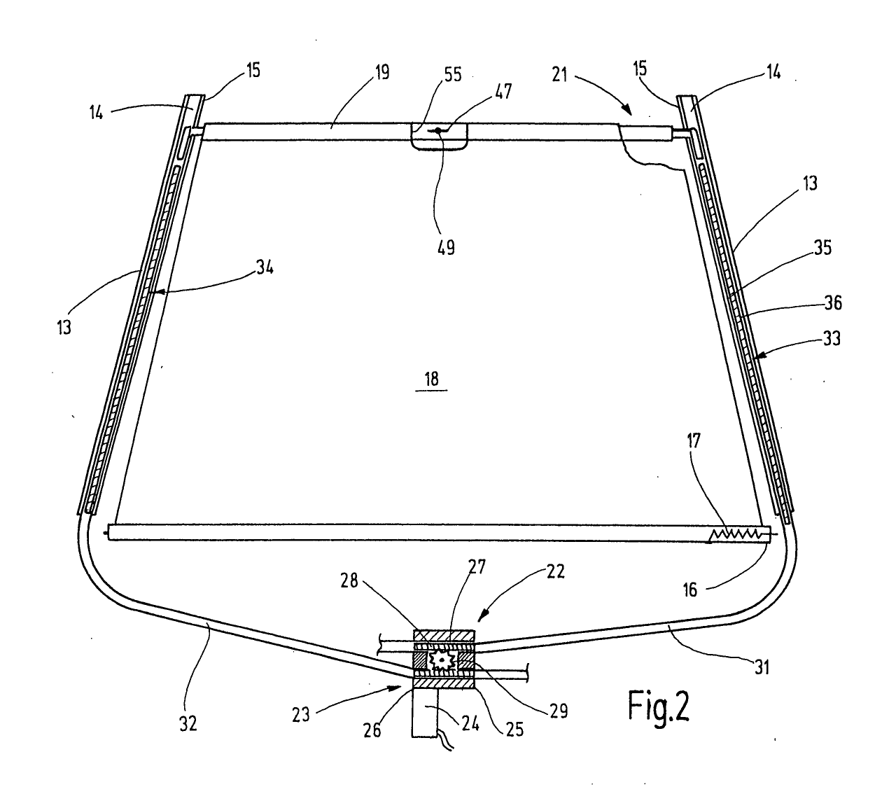

The slot 11 in the rear window shelf forms part of a rear window shade 12, the basic design of which is illustrated in a highly schematic fashion in FIG. 2. The rear window shade 12 includes two guide rails 13 that are mounted adjacent to the lateral edges of the rear window opening 7 on the two C columns 4 and 5. Each guide rail 13 inlcudes an undercut guide groove 14 with a slot 15 that opens outward. In FIG. 2, the guide rails 13 are illustrated in cross section. The guide rails 13 extend downward underneath the rear window shelf 9 through the slot 11.

As schematically shown in FIG. 2, a winding shaft 16 is rotatably supported underneath the rear window shelf. The bearing devices associated with the winding shaft are not shown because they would be readily understood by those skilled in the art. The winding shaft 16 has a tubular shape and accommodates a spring drive 17. In this case, the spring drive 17 consists of a coil spring, one end of which is fixed in the interior of the winding shaft 16 and the other end of which is anchored onto one of the support brackets for the winding shaft 16.

One edge of a shade element 18 is fixed on the winding shaft 16. The shade element has a trapezoidal shape that approximately corresponds to the contour of the rear window 6. The opposite edge of the shade element is rolled into a tubular loop 19 for accommodating an extraction rod 21. The extraction rod 21 is fixed in the loop 19 relative to the longitudinal direction of the extraction rod 21.

A drive unit 22 is provided for extracting the shade element 18 as shown schematically in FIG. 2. In this instance, the drive unit 22 comprises a geared motor 23 that is composed of a permanently excited DC motor 24 and a gear casing 25. The gear casing 25 contains two parallel guide channels 26 and 27, between which an output gear 29 is provided on an output shaft 28. The output gear 29 can be selectively turned in both rotational directions by means of the output shaft 28, which is connected to the output gear in a rotationally rigid fashion. A guide tube 31 extends from the guide channel 27 to the lower end of the guide groove 14 in the right guide rail 13. On the left side, the guide channel 26 is connected to the lower end of the guide groove 14 in the left guide rail 13 by means of a guide tube 32.

Elastically bendable thrust elements 33 and 34 extend into the corresponding guide groove 14 through the guide channel 26 and the guide tube 32, as well as through the guide channel 27 and the guide tube 31. The respectively unused sections of the thrust elements 33, 34 are retracted into storage tubes that originate on the opposite ends of the guide channels 26, 27. Both thrust elements 33 and 34 have the same design. In particular, each thrust element consists of an elastically bendable core 35 that carries one or more ribs 36 on its outer side such that the ribs form a single or multiple thread. The ribs 36 protrude radially and extend helically over the cylindrical core 35 from one end of the thrust element 33, 34 to the other end. The output gear 29 has teeth that are able to engage between the grooves formed by the ribs 36. In this way, the output gear 29 is positively coupled to the thrust elements 33 and 34.

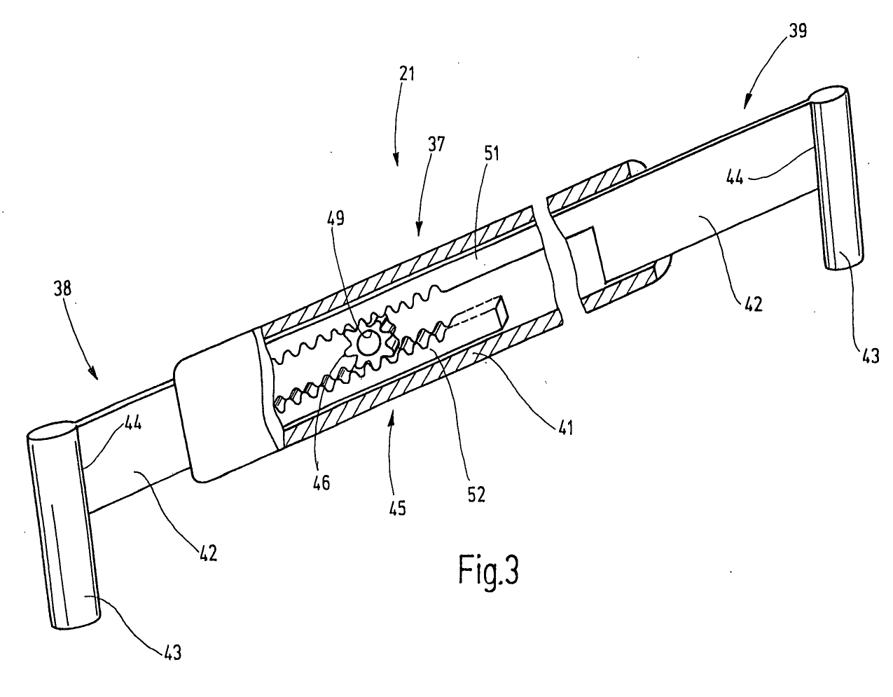

The extraction rod 21 generally includes a center piece 37 and two end pieces 38 and 39 that can be telescopically moved relative to the center piece 37 as shown in FIG. 3. The center piece 37 consists of an oval tube 41 with a constant cross section along its length. The flat sides of the tube lie parallel to the plane of the extracted shade element 18. The length of the tube 41 corresponds to the length of the tubular loop 19 and consequently to the corresponding edge of the strip shaped shade 18.

The end piece 38 has an L-shape and includes an arm 42 and a guide piece 43. The arm 42 has a cross sectional configuration that allows the arm to be longitudinally displaced in the interior of the tube 41 essentially without any play. At the location identified by the reference symbol 44 in FIG. 3, the outer end of the arm 42 integrally transforms into the guide piece 43. The cross sectional shape of the arm is adapted to the circular part of the guide groove 14 and the width of the arm 42 corresponds to the width of the slot 15. With respect to the arm 42 and the guide piece 43, both end pieces 38 and 39 are designed identically.

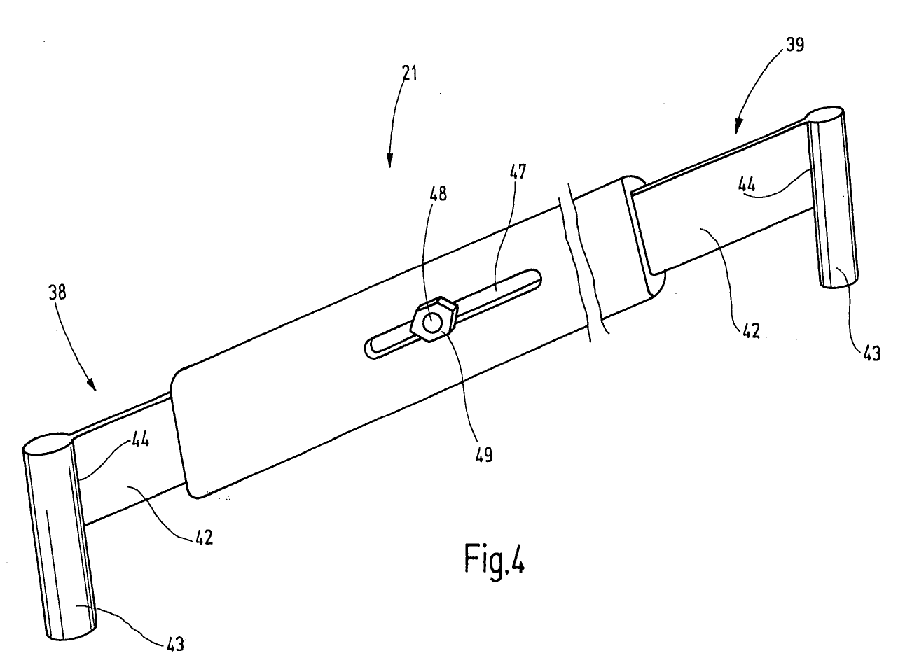

A differential gear 45 is arranged approximately in the center of the tube 41. The differential gear 45 includes a pinion gear 46 that is freely rotatable about an axis that extends perpendicular to the longer axis of the cross-sectional profile of the tube 41. As shown in FIG. 4, an oblong hole 47 is provided in the flat side of the tube 41 at the location of the pinion gear 46. This oblong hole is aligned with an oblong hole on the opposite flat side of the tube. The oblong holes 47 lie parallel to the longitudinal direction of the loop 19 and consequently to the lateral edge of the shade element 18.

The pinion gear 46 contains a throughbore 48, the diameter of which corresponds to the width of the oblong hole 47. A cap screw 49 extends through the two oblong holes 47 and the bore 48 of the pinion gear 46, with the screw head of the cap screw lying on the rear side relative to FIG. 4. On the front side, a locking nut 50 is screwed onto the threaded shaft of the screw 49. The screw 49 serves as the bearing axis for the pinion gear 46 that is freely rotatable on the screw 49.

If necessary, the moveability of the pinion gear 46 can be improved by rotatably supporting the pinion gear in a bushing seated on the screw 49. The bushing serves as a spacer for preventing the cross-sectional profile of the tube 41 from being deformed to such a degree when the nut 50 is tightened that the pinion gear 46 jams in the interior of the tube 41. Such bearing arrangements are well known to persons skilled in the art. Accordingly, the bearing arrangements are not illustrated in the drawings in order to prevent unnecessary details from complicating the drawings.

The centering mechanism 35 also includes two racks 51 and 52 that mesh with the pinion gear 46. As shown in FIG. 3, one of the racks extends underneath the pinion gear 46, while the other rack 51 is guided above the pinion gear in the tube 41. One end of the rack 51 is integrally connected to the arm 42.

The operation of the centering mechanism will be readily understood by those skilled in the art. When the end piece 39 is longitudinally displaced relative to the tube 41, the pinion gear 46 is turned by the rack 51. This rotation causes the rack 52 to move opposite to the rack 51, with the rack 52 being displaced by the same distance, however, in the opposite direction. This causes the corresponding end piece 38 to be displaced relative to the center piece 37, namely by a distance that corresponds to the displacement of the other end piece 39, however, in the opposite direction. Thus, the center piece 37 is exactly centered between the two guide pieces 43. This exactly centered position is maintained if one of the two end pieces 38, 39 is displaced. The centered position of the center piece 37 is also maintained if an external force causes the two end pieces 38, 39 to move toward or apart from one another. As will be understood, the length of the racks 51, 52 corresponds to the required displacement. In addition, the part of the arms 42 that does not contain a rack has a length that provides a sufficient telescopic guidance in the tube 41 so as to avoid any jamming over the entire displacement range.

The required position of the center piece 37 does not necessarily have to lie exactly in the center between the two end pieces 38, 39. On the contrary, the position of the center piece 37 depends on the position of the shade element 18. The center piece 37 can be adjusted in such a way that no lateral forces that lead to transversely extending longitudinal creases occur in the shade element 18 in the extracted state. To this end, the position of the differential gear 45 can be varied. In this case, the nut 50 is loosened through a corresponding recess 53 in the loop 19 once the window shade is installed in the motor vehicle. The corresponding screw 49 that serves as the bearing axis for the pinion gear 46 can now be adjusted along the oblong hole 47. The center piece 37 formed by the tube 41 can be displaced in the desired direction on the arms 42 without actuating the pinion gear 46 and, consequently, without changing the distance between the end pieces. The center piece can be displaced until the transverse creases in the shade element 18 have disappeared. The nut 50 is retightened in this position such that the bearing axis is fixed in the oblong hole 47. The differential gear 45 then operates as described above.

When a user actuates the gear motor 23 in the extracting direction, the thrust elements 33, 34 are displaced in the direction of the corresponding guide rails 13. The guide pieces 43 seated in the grooves 14 are displaced by the thrust elements. The guide pieces 43 are rigidly connected to the center piece 37 and also drive the shade element 18. The shade element 18 is continuously unwound from the winding shaft 16 against the force of the spring drive 17. The shade element 18 is held in a tensioned state between the extraction rod 21 and the winding shaft 16 in any operating position. Viewed from the vantage point of the moving extraction rod 21, the two guide rails 13 continuously converge. This causes the end pieces 38, 39 to move toward one another. This relative movement actuates the pinion gear 46, the bearing axis of which is fixed in the center piece 37. The center piece 37 consequently will always maintain a centered position, i.e., the end pieces 38, 39 are respectively displaced relative to the center piece 37.

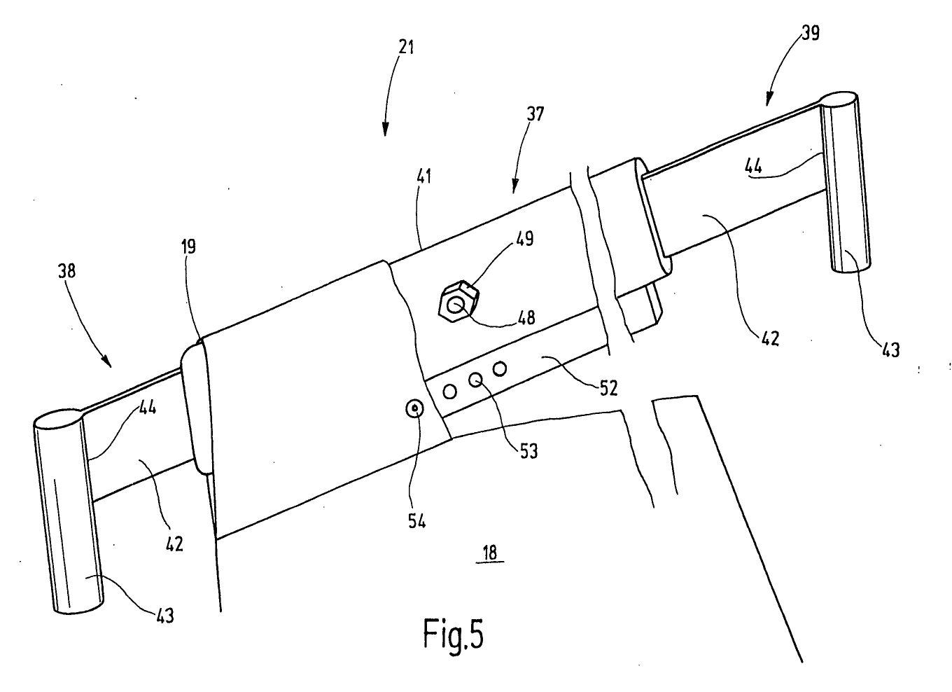

An alternative arrangement for adjusting the differential gear 45 relative to the transverse edge of the strip shaped shade 18 is illustrated in FIG. 5. In this embodiment, the differential gear 45 in the center piece 37 has the same configuration as the differential gear described above with reference to FIG. 3. However, the oblong hole 47 is replaced with a simple through hole such that the axis of the pinion gear 46 cannot be displaced in the longitudinal direction of the center piece 37. In contrast to the embodiment of FIG. 3, the underside of the tube 41 forming the center piece 37 contains a continuous strip 52 that extends over the entire length of the tube and is provided with openings 53 that are uniformly spaced apart from one another.

During installation of the window shade of the present invention, the shade element 18 is initially extracted. Subsequently, the upper edge of the shade element 18 having the loop 19 is displaced on the center piece 37, which is fixed in the longitudinal direction between the end pieces 38 and 39 due to the differential gear 45. The displacement can continue until the transversely extending longitudinal creases have disappeared. In this position, the upper transverse edge of the shade element 18 is not laterally offset relative to the section wound onto the winding shaft 11. A blind rivet 56 is then inserted through an opening 53 that is situated approximately in the center, with the blind rivet simultaneously penetrating the material of the shade element 18 on both sides in the region of the loop 19. This longitudinally fixes the edge of the shade element relative to the extraction rod 21. During subsequent extraction operations, the shade element 18 reaches exactly the same position, in which no transverse creases are formed, even if the extraction rod 21 attempts to slide into the loop 19 in the lower retracted region due to clearance in the lateral position of the guide rails 13.

A window shade for motor vehicles is provided that includes a rotatably supported winding shaft with one edge of a shade element fixed thereon. The other edge of the shade element is captured on an extraction rod, the ends of which are guided in guide rails. The distance between the guide rails changes significantly in the moving direction of the shade element, and therefore the length of the extraction rod can be telescopically varied. The extraction rod includes a center piece and two end pieces, with a differential gear ensuring that the center piece always remains centered relative to the end pieces. The position of the differential gear is adjustable in the longitudinal direction of the transverse edge of the shade element.

1. A window shade for regulating light radiating into the interior of a motor vehicle through a window, comprising:
a rotatably supported winding shaft;
a shade element having a first edge fixed to the winding shaft;
a pair of guide elements each of which extends laterally adjacent to the shade element in an extracted position, each of the guide elements including a guide groove;
an extraction rod of variable length connected to a second edge of the winding shaft, the extraction rod including a center piece and two end pieces, wherein each end piece having a guide piece guided in a respective one of the guide grooves; and
a differential gear for at least approximately centering the center piece relative to the end pieces, the differential gear oppositely transmitting the movement of one end piece relative to the center piece to the other end piece, wherein the position of the differential gear relative to the second edge of the shade element is adjustable in a longitudinal direction of the extraction rod.

2. The window shade according to claim 1, wherein the differential gear displaces both end pieces by the same distance.

3. The window shade according to claim 1, wherein the center piece comprises a tube.

4. The window shade according to claim 3, wherein the tube has a non-circular cross-sectional profile.

5. The window shade according to claim 1, wherein the end pieces are telescopically guided in the center piece.

6. The window shade according to claim 1, wherein the differential gear comprises a positive engagement gear.

7. The window shade according to claim 1, wherein the differential gear comprises a frictional engagement gear.

8. The window shade according to claim 1, wherein the differential gear comprises a gear wheel that is supported by the center piece and two racks that mesh with the gear, wherein each rack is connected to one of the end pieces.

9. The window shade according to claim 1, wherein the differential gear has an axial element that extends into an oblong hole and the oblong hole has a long axis that extends parallel to the longitudinal axis of the center piece.

10. The window shade according to claim 9, characterized by the fact that the axial element can be fixed in the oblong hole.

11. The window shade according to claim 1, wherein the center piece in a tubular loop formed on the edge of the shade element.

12. The window shade according to claim 11, wherein the loop is provided with a mechanism for fixing the center piece in a desired position in the loop.

13. The window shade according to claim 1, wherein the guide grooves extend laterally with respect to the extracted shade element.

14. The window shade according to claim 1, wherein the guide grooves comprise undercut guide grooves.

15. The window shade according to claim 1, further including a drive unit for displacing the extraction rod along the guide rails and for turning the winding shaft.

16. The window shade according to claim 15, wherein the winding shaft includes a spring drive that prestresses the winding shaft in a wind up direction.

17. The window shade according to claim 15, wherein the drive unit comprises two driving elements for displacing the extraction rod.

18. The window shade according to claim 15, wherein the drive unit comprises a geared motor.

19. The window shade according to claim 17, wherein the driving elements comprise flexible, linear thrust elements that are guided in a buckle proof fashion between a geared motor and a corresponding guide groove.

20. The window shade according to claim 17, wherein the driving elements comprise approximately cylindrical structures each of which is provided with teeth on an outer surface, the teeth being arranged over the length of the driving element with a constant pitch.

21. The window shade according to claim 20, wherein the teeth are formed by a rib that extends in a helical path on the outer side of the cylindrical structure.

22. The window shade according to claim 17, wherein the driving elements cooperate with a geared motor.

23. The window shade according to claim 1, wherein the shade element consists of a knitted fabric or a perforated sheet.
